(19) United States
(12) Patent Application Publication
(10) Pub. No.: US 2005/0256278 A1
(43) Pub. Date: Nov. 17, 2005

(54) Tack-free low VOC vinylester resin and uses thereof

(76) Inventors: L. Scott Crump, Gladstone, MO (US); Ming Yang Zhao, Kansas City, MO (US)

Correspondence Address: WHYTE HIRSCHBOECK DUDEK S C, 555 EAST WELLS STREET, SUITE 1900, MILWAUKEE, WI, 53202, US

(21) Appl. No.: 10/846,354

(22) Filed: May 14, 2004

(51) Int. Cl. C08G 59/16

(52) U.S. Cl. 525/531

(57) ABSTRACT

Low VOC vinyl ester resins exhibit improved cure in an oxygen containing environment. The vinyl ester resins comprise the reaction product of an epoxy resin having at least two epoxy groups per molecule; a polybasic anhydride; unsaturated monobasic acids comprising up to about 10 molar percent dicyclopentadienyl monomaleate based on the total unsaturated monobasic acids, wherein the vinyl ester resin has a viscosity of less than about 1200 cp measured at a shear of 500 s⁻¹ in styrene at 70% non-volatile matter. Barrier coats and gel coats comprising such vinyl ester resins have acceptable tackiness and physical characteristics. A process to make such vinyl ester resins is also described.

### BACKGROUND OF THE INVENTION

The present invention relates to a modified vinyl ester resin capable of providing a tack-free cured product having an excellent water resistance, and a low viscosity water barrier coat composition containing the modified vinyl ester resin.

Vinyl ester resin (i.e., an epoxy acrylate resin) can be cured with initiator, heat or light, and its physical properties are excellent. Due to such advantages, vinyl ester resin is used as a curable resin in applications such as various molding materials and coating materials, including barrier coats for marine applications. The barrier coat is applied between the gel coat and main laminate in the construction of composite materials, which are used in the water or heavy moisture environments, such as boat hulls, and water craft frame.

Vinyl ester resins are generally prepared by reaction in an epoxy resin with an unsaturated monobasic acid, and mixed with a polymerizable monomer such as styrene, in order to reduce their viscosity. When cured, the styrene becomes a part of the resin system to produce a rigid cross-linked structure with desirable properties. Conventional vinyl ester resin usually contains 45%-35% (weight) of styrene or other volatile organic compounds (VOC). The high reactivity of styrene also leads to a faster curing process.

The presence of large amounts of styrene in such resin compositions results in the emission of styrene vapors into the work atmosphere which constitutes a hazard to workers and the environment. In view of this environmental hazard, governments have established regulations setting forth guidelines relating to volatile organic compounds (VOC) which may be released to the atmosphere. The U.S. Environmental Protection Agency (EPA) has established guidelines limiting the amount of VOC released to the atmosphere, such guidelines being scheduled for adoption or having been adopted by various states of the United States. Guidelines relating to VOC, such as those of the EPA, and environmental concerns are particularly pertinent to the gel coat and other coating industry which use styrene or organic solvents and these VOC are emitted into the atmosphere.

To reduce styrene content and VOC in polymeric vehicles and formulated coating, researchers try to develop low VOC resin compositions in which VOC in the coating is kept at the lowest possible level.

One way to reduce VOC is to reduce the molecular weight of the resin. According to polymer physics theory, the viscosity of polymers in the liquid state depends mainly on the average molecular weight, so it is desirable to reduce average molecular weight for low VOC product. Low molecular weight leads to a lower viscosity and lower styrene need.

Compared with conventional vinyl ester resin, which has higher molecular weight and higher styrene content, the low VOC vinyl ester resin usually contain 30% or less styrene.

While each have advantages, each resin composition had disadvantages. While the conventional high molecular weight resin tends to get tack-free curing surface, the coating or gel coat made with lower molecular weight resin tends to remain tacky for long periods of time in application. The tacky is because of the oxygen inhibition on radical polymerization.

Vinyl ester resin may be polymerized in bulk by free radical polymerization initiated by high-energy radiation, particle beams or chemical sources of free radicals such as peroxides and hydro-peroxides. It is also well known that free radical polymerization of vinyl ester resins may be inhibited by oxygen. Oxygen inhibition on polymerization becomes particularly troublesome in surface coating compositions such as those used in boat hull surfaces. The surface of the composition may be very slow to cure since the presence of oxygen inhibits surface curing. This results in a surface having such undesirable properties as tacky and residual odor.

A variety of techniques have been used in an attempt to resolve the problem presented by oxygen inhibition of polymerization.

For example, a film-forrming material, such as paraffin wax may be included in the coating composition in order to prevent air inhibition and deduce the vaporization (for example, EP 0369683, JP 2002-097233). Paraffin or hydrocarbon waxes tend to migrate to the surface of the vinyl ester resin and serve as a film which reduces oxygen penetration at the coating surface. However, the wax surface will reduce secondary adhesive properties.

Air drying group, such as allyl ether are commonly used to promote surface curing. Some methods based on allyl ether have been reported (for example, JP 61101518, JP 63265911). The incorporation of allyl ether may lead to poor physical properties.

Another method to get tack-free surface cure is based on dicyclopentadiene (DCPD).

DCPD alkenoates, such as DCPD acrylate, DCPD furmarate or DCPD unsaturated polyester, are blended with vinyl ester resin to obtain air drying and other properties (for example, EP9055, JP 1990-135208, U.S. Pat. No. 4,480,077, U.S. Pat. No. 4,753,982).

Dicyclopentadienyl monomaleate is adduct of DCPD and maleic acid. It is made usually from DCPD, maleic anhydride and water. It was reported that dicyclopentadienyl monomaleate was reacted with epoxy resin to prepare DCPD based vinyl ester resins (U.S. Pat. No. 4,525,544, JP 2002-317021). The obtained resins should be tack-free on surface cure but the physical properties of the cured resins are poor because of the low reactivity of some left maleate groups.

None of these solutions to the problem arising from oxygen inhibition of surface cure has been totally satisfactory. There remains a significant need for vinyl ester resin which rapidly develop surface cure, especially in the case of low VOC resins which contain relatively low volatile vinyl monomers.

Low VOC and the tack-free property are inconsistent characteristics with each other. The improvement of the tack-free tends to impair the low VOC property. There is a difficulty in attaining both low VOC and good tack-free property.

There is no report on the vinyl ester resin with both low VOC and tack-free properties.

### BRIEF SUMMARY OF THE INVENTION

This invention provides a new low VOC vinyl ester exhibiting improved cure in an oxygen containing environment. This invention also provides a new resin composition that may be formulated to a gel coat that has excellent water resistance.

In a preferred embodiment, the invention is a vinyl ester resin comprising the reaction product of an epoxy resin having at least two epoxy groups per molecule; a polybasic anhydride; unsaturated monobasic acids comprising up to about 10 molar percent dicyclopentadienyl monomaleate based on the total unsaturated monobasic acids, wherein the vinyl ester resin has a viscosity of less than about 1200 cp measured at a shear of 500 s⁻¹ in styrene at 70% non-volatile matter.

In another preferred embodiment, the invention is a barrier coat or gel coat comprising: (i) a vinyl ester resin comprising the reaction product of: an epoxy resin having at least two epoxy groups per molecule; a polybasic anhydride; and unsaturated monobasic acids comprising up to about 10 molar percent dicyclopentadienyl monomaleate based on the total unsaturated monobasic acids, and (ii) a reactive monomer, wherein the vinyl ester resin has a viscosity of less than about 1200 cp measured at a shear of 500 s⁻¹ in styrene at 70% non-volatile matter.

In yet another preferred embodiment, the invention is a process for preparing a vinyl ester, the process comprising the steps of: (i) combining an epoxy resin having at least two epoxy groups per molecule, a polybasic anhydride; and unsaturated monobasic acids comprising up to about 10 molar percent dicyclopentadienyl monomaleate based on the total unsaturated monobasic acids to form a reaction mixture; and, (ii) heating the reaction mixture such that the reaction mixture reacts to form a vinyl resin, wherein the vinyl ester resin has a viscosity of less than about 1200 cp measured at a shear of 500 s⁻¹ in styrene at 70% non-volatile matter.

### BRIEF DESCRIPTION OF THE DRAWINGS

FIG. 1 shows the chemical structure of an example of the resin.

FIG. 2 shows the chemical structure of another example of the resin.

FIG. 3 shows the chemical structure of a comparative sample resin.

FIG. 4 shows the chemical structure of another comparative sample resin.

FIG. 5 shows the chemical structure of another comparative sample resin.

### DETAILED DESCRIPTION OF THE INVENTION

Unless otherwise specified herein, the term “viscosity” refers to the viscosity of a polymer in styrene monomer at 70 wt. % NVM (non-volatile material, see below) at 25° C. measured using a Brookfield Viscometer.

In a preferred embodiment, the low VOC vinyl ester resin of this invention have a viscosity not greater than about 1000 cp, when the resin is dissolved in 30 wt. % styrene based on the total weight of resin and styrene.

The term “NVM” refers to non-volatile material dispersed in a volatile substance (e.g., styrene monomer) measured according to ASTM D1259.

The vinyl ester resins of this invention are made by reacting an epoxy resin having at least two epoxy groups per molecule (also called polyepoxides herein), a dicyclopentadienyl monomaleate, a polybasic anhydride and an unsaturated monobasic acid in limited ratios.

Preferred polyepoxides are the glycidyl polyethers of polyhydric phenols and polyhydric alcohols, especially the glycidyl polyethers of 2,2-bis(4-hydroxyphenyl) propane (also known as bis-phenol A) having an average molecular weight between about 300 and 3,000 and an epoxide equivalent weight between about 140 and 2,000. The epoxide equivalent weight is the molecular weight of the epoxy resin divided by the number of epoxy groups per molecule of the resin.

Other suitable epoxy compounds include those compounds derived from polyhydric phenols and having at least one vicinal epoxy group wherein the carbon-to-carbon bonds within the six-membered ring are saturated. Such epoxy resins may be obtained by at least two well-known techniques, i.e., (1) by the hydrogenation of glycidyl polyethers of polyhydric phenols or (2) by the reaction of hydrogenated polyhydric phenols with epichlorohydrin in the presence of a suitable catalyst such as Lewis acids, i.e., boron trihalides and complexes thereof, and subsequent dehydrochlorination in an alkaline medium. The method of preparation forms no part of the present invention and the resulting saturated epoxy resins derived by either method are suitable in the present compositions.

The polyepoxide is reacted in esterification reactions with both monobasic and polybasic organic carboxylic acids as long as the acids comprise dicyclopentadienyl monomaleate. The monobasic acids are preferably monocarboxylic acids or partial esters of polycarboxylic acids. The organic carboxylic acid used to esterify the polyepoxide may be saturated or unsaturated and may be aliphatic, cycloaliphatic or aromatic. The preferred monocarboxylic acids, include, for example, acetic acid, propionic acid, benzoic acid, toluic acid, cyclohexanecarboxylic acid, methylcyclohexanecarboxylic acid, cyclopentanecarbocyclic acid, acrylic acid, methacrylic acid, stearic acid, lauric acid, dodecanoic acid, chloracetic acid, phenoxyacetic acid and the like. More preferably, the monocarboxylic comprise ethylenically unsaturated acids, such as, for example, acrylic acid, methacrylic acid, crotonic acid, alpha-phenylacrylic acid, alphacyclohexlacrylic acid, cyanoacrylic acid, methoxyacrylic acid, and the like, most preferably acrylic acid or methacrylic acid.

Also particularly preferred are the partial esters of polycarboxylic acids, and particularly the alkyl, alkenyl, cycloalkyl and cycloalkenyl esters of polycarboxylic acids. One such partial esters of polycarboxylic acid, dicyclopentadienyl monomaleate, must be present. In addition, other partial esters of polycarboxylic acid which may be present include, for example, allyl hydrogen maleate, butyl hydrogen maleate, allyl hydrogen phthalate, allyl hydrogen succinate, allyl hydrogen fumarate, butenyl hydrogen tetrahydrophthalate, cyclohexenyl hydrogen maleate, cyclohexyl hydrogen tetrahydrophthalate, and the like, and mixtures thereof.

The dicyclopentadienyl monomaleate is an adduct usually made from dicylopentadiene (DCPD), maleic anhydride and water or DCPD alcohol and maleic anhydride. The dicyclopentadienyl monomaleate can be prepared in a separate prior reaction or in situ in the same reaction vessel as the esterification reaction. In situ production of the dicyclopentadienyl monomaleate should be conducted prior to adding the ingredients for the esterification reaction. Preparation of dicyclopentadienyl monomaleate is known in the art and is disclosed, for example, in U.S. Pat. No. 4,525,544, incorporated herein by reference.

The dicyclopentadienyl monomaleate is present in an amount up to about 10 molar percent based on the total amount of monobasic acids present.

Polycarboxylic acids are also used in the production of the inventive resin. Suitable polycarboxlyic acids include, for example, maleic acid, alpha-chloromaleic acid, tetrahydrophthalic acid, itaconic acid, trimellitic acid, fumaric acid and their anhydrides, preferably the anhydrides.

An esterification catalyst is not required, however, the use of such a catalyst is highly desired. In general, any esterification catalyst is suitable for use to prepare vinyl esters including the metal hydroxides such as sodium hydroxide; tin salts such as stannous octoate; phosphines such as triphenyl phosphine; the onium salts such as the phosphonium salts, including the phosphonium and ammonium halides.

Preferred esterification catalysts comprise the onium salts, and preferably those containing phosphorus, sulfur or nitrogen, such as, for example, the phosphonium, sulfonium and ammonium salts of inorganic acids. Examples of these include, among others, benzyltrimethylammonium sulfate, tetramethylammonium chloride, benzyltrimethylammonium sulfate, tetramethylammonium chloride, benzyltrimethylammonium nitrate, diphenyldimethylammonium chloride, benzyltrimethylammonium chloride, diphenyldimethylammonium nitrate, diphenylmethylsulfonium chloride, tricyclohexylsulfonium bromide, triphenylmethylphosphonium iodide, diethyldibutylphosphonium nitrate, trimethylsulfonium chloride, dicyclohexyldialkylphosphonium iodide, benzyltrimethylammonium thiocyanate, and the like, and mixtures thereof.

The amount of the above-noted polyepoxide and acid to be used in the reaction may vary over a wide range. In general, these reactants are used in approximately chemical equivalent amounts. As used herein and in the appended claims a chemical equivalent amount of the polyepoxide refers to that amount needed to furnish one epoxy group per carboxyl group. Excess amounts of either reactant can be used. Preferred amounts range from about 0.5 to 2 equivalents of carboxylic acid per equivalent of epoxide.

The amount of the catalyst employed may also vary over a considerable range. In general, the amount of the catalyst will vary from about 0.01% to about 3% by weight, and more preferably from 0.3% to 2% by weight of the reactants.

The reaction may be conducted in the presence or absence of solvents or diluents. In most cases, the reactants will be liquid and the reaction may be easily effected without the addition of solvents or diluents. However, in some cases, whether either or both reactants are solids or viscous liquids it may be desirable to add diluents to assist in effecting the reaction. Examples of such materials include the inert liquids, such as inert hydrocarbons as xylene, toluene, cyclohexane and the like.

If solvents are employed in the reaction and the resulting product is to be used for coating purposes, the solvent may be retained in the reaction mixture. Otherwise, the solvent can be removed by any suitable method such as by distillation and the like. If the product is to be stored for a prolonged time after its formation, it may also be desirable to remove the catalyst used in the preparation, such as by stripping, neutralization and the like.

Temperatures employed in the reaction will generally vary from about 50° C. to about 150° C. In most cases, the reactants will combine in the presence of the new catalyst at a very rapid rate and lower temperatures will be satisfactory. Particularly preferred temperatures range from about 60° C. to 120° C.

The reaction will be preferably conducted at atmospheric pressure, but it may be advantageous in some cases to employ subatmospheric or superatmospheric pressures.

The course of the reaction may be conveniently followed by determination of the acidity. The reaction is considered to be substantially complete when the acidity has been reduced to about 0.015 eq/100 grams or below.

The process of the invention may be effected in any suitable manner. The preferred method merely comprises adding the polyepoxide, acid, catalyst, and solvent or diluent if desired, in any order and then applying the necessary heat to bring about the reaction. The reaction mixture may then be distilled or stripped to remove any of the unnecessary components, such as solvent, catalyst, excess reactants and the like.

The polyester products obtained by the above process will vary from liquids to solid resins. The products will possess a plurality of free OH groups and a plurality of ethylenic groups. The products will be of higher molecular weight than the basic polyepoxide from which they are formed and will possess at least more than one ester group per polyepoxide unit.

These vinyl esters may then be modified, if desired, by further reaction with a polycarboxylic acid anhydride such as maleic anhydride.

The resulting vinyl esters or modified vinyl esters may be mixed or blended with one or more compatible unsaturated monomers, examples of such monomers include, among others, aromatic compounds such as styrene, alpha-methylstyrene, dichlorostyrene, vinyl naphthalene, vinyl phenol and the like, unsaturated esters, such as acrylic and methacrylic esters, vinyl laurate, and the like, unsaturated acids, such as acrylic and alpha-alkylacrylic acids, butenoic acid, allylbenzoic acid, vinylbenzoic acid, and the like, halides, such as vinyl chloride, vinylidene chloride, nitriles, such as acrylonitrile, methacrylonitrile, diolefins, such as butadiene, isoprene, methylpentadiene, esters of polycarboxylic acids, such as diallyl phthalate, divinly succinate, diallyl mateate, divinyl adipate, dichloroallyl tetrahydrophthalate, and the like, and mixtures thereof.

The amount of unsaturated monomer will vary widely; however, the weight ratio of polyester to unsaturated monomer will generally vary from about 100.0:0.0 to about 30.0:70.0, with from about 95.0:5.0 to about 35.0:65.0 being preferred, and from about 60.0:40.0 to 40.0:60.0 being especially preferred.

Especially preferred unsaturated comonomers are the aromatic unsaturated compounds such as styrene, vinyl toluene and divinyl benzene. Since styrene or other polymerizable, vaporizable, ethylenically unsaturated monomer is a volatile component which tends to be released to the atmosphere during storage and/or curing of the thermosettable vinyl ester and unsaturated polyester resins, it is becoming more and more desirable to reduce the level of styrene or other polymerizable, vaporizable monomer which is released to the atmosphere during storage and/or cure.

The stabilizers are used to stabilize the resins during storage. Suitable stabilizers include the sterically hindered phenols, sulfides and amines.

Examples of especially preferred stabilizers include, among others, 2,6 di-tertiary butyl-4-methylphenol, 1,3,5-trimethyl-2,4,6-tri(3′,5′-di-tertiarybutyl-4′-hydroxybenzyl)benzene, octadecyl 3-(3′,5′-di-tertiary butyl-4′-hydroxyphenyl)propionate, 4,4′-methylene bis(2,6-di-tertiary butylpheonol), zinc dibutyl dithiocarbamate. Exceptional color stability is achieved with these sterically hindered phenols.

The hydroquinone is preferably added during the esterification step but may be added at any time and the stabilizer is preferably added to the finished vinyl ester or vinyl ester/styrene blend.

In general, the amount of each stabilizer employed in the blend will vary widely. Accordingly, a stabilizing amount consistent with the end color desirable is employed. Operable amounts usually range from about 2 to about 400 ppm of hydroquinone and from about 2 to about 600 ppm of the stabilizer, based on the weight of the resin. A very effective amount is from about 50 to about 250 ppm of hydroquinone and from about 50 to about 500 ppm of stabilizer. The amount of any additional gellation inhibitor may vary widely and may range from about 100 to about 10,000 ppm.

The resulting stabilized vinyl ester or vinyl ester blend can be converted to very suitable coating with the addition of a curing agent or use of UV-radiation.

Examples of suitable vinyl ester resin curing agents (catalysts) are the free-radical yielding compounds and suitable radiation. Examples of such catalysts includes the peroxides, such as benzoyl peroxide, tertiary butyl hydroperoxide, ditertiary butyl peroxide, hydrogen peroxide, potassium persulfate, methyl cyclohexyl peroxide, cumene hydroperoxide, acetyl benzoyl peroxide. Tetralin hydroperoxide, phenylcyclohexane hydroperoxide, tertiary butylisopropylbenzene hydroperoxide, tertiary butylperacetate, tertiary butylacetate, tertiary butyl perbenzoate, ditertiary amyl perphthalate, ditertiary butyl peradipate, tertiary amyl percarbonate, and the like, and mixtures thereof; azo compounds such as 2,2′-azobisisobutyronitrile, dimethyl 2,2′-azobisisobutyrate, 2,2′-azobis(2,4-diamethylvaleronitrile, 2,2′-azobisisotulyamide, and the like. Particularly preferred catalysts include the diaroyl peroxide, tertiary alkyl hydroperoxides, alkyl peresters of percarboxylic acids and particularly those of the above noted groups which contain no more than 18 carbon atoms per molecular and have a decomposition temperature below 125° C.

Of course, other materials may be mixed or added, including, plasticizers, stabilizers, extenders, oils, resins, tars, asphalts, pigments, reinforcing agents, thioxotropic agents, and the like.

The present resin compositions may be utilized in many applications such as for coatings and reinforced composite products, such as laminated products, filament windings, sheet molding compounds (SMC). A very suitable application is in the preparation of gel coat, such as barrier coat, skin coat, tooling gel coat and the like.

It is known that gel coated fiber-reinforced polymers are subject to blistering if immersed in water or solvents for a prolonged period of time unless special measures are taken to prevent this phenomenon. Blisters are raised by localized swelling of the gel coated laminate due to diffusion of water into the composite and the presence of water-soluble constituents within the laminate. The blisters not only affect the external appearance of the gel coated fiber-reinforced polymer article, but also eventually lead to reduced composite strength.

Vinyl ester resin based barrier coat has excellent water resistance to protect the composite material from hydrolysis and blister. Vinyl ester resin compositions which may be used in the laminate construction to impart greater resistance to water permeation.

An advantage of interposing the barrier coat from the thermoset resin of the present invention between a gel coat layer and the fiber-reinforced polymer layer is the prevention, or minimization, of blistering due to the migration of water and/or other low molecular weight substances, such as organic solvents, through the gel coat into the fiber-reinforced polymer, causing swelling, delamination, and other problems in the fiber-reinforced polymer layer.

The polyester resin used to make the fiber-reinforced polyester resin may be any general purpose polyester resin known in the art, such as orthophthalic acid-based polyester resins.

The gel coated and barrier coated composites usually are constructed in several curing process. First, a gel coat is usually applied to the surface of the mold, at least partially cured, and then a barrier coat is applied over the at least partially cured gel coat. These are open mold operations. Then the fiber-reinforced polyester matrix precursor is applied, for example, by hand lay-up or spray-up, or the fiber reinforcement is applied to the barrier coat. The precursor is then allowed to cure, with or without a heat supplement, and the part or article demoulding.

For a large composite, such as a big boat, the fiber reinforcement process only can start after forming a tack-free barrier coat surface. In this application the ability of forming the coating layer with tack-free property is an important requirement for the barrier coat resin composition.

### EXAMPLES

The following examples are given to illustrate the preparation and test of the resin. It is understood that the examples are preferred embodiments only and are given for the purpose of illustration and the invention is not to be regarded as limited to any specific components and/or specific conditions recited therein. Unless otherwise indicated, parts and percentages in the examples, are parts and percentages by weight.

Epoxy Resin A is a liquid glycidyl polyether 2,2-bis(4-hydroxyphenyl)propane having an epoxide equivalent weight of 186.

Unless specified otherwise, all ratios, percentages, and parts are by weight. The formulations are summarized in Table 1A for the Examples of this invention and Table 1B for the Comparative Samples.

TABLE 1-A
Examples

| | EXAMPLE1 | | EXAMPLE 2 | | EXAMPLE 3 | |
|---|---|---|---|---|---|---|
| Ingredient | weight (g) | weight % | weight (g) | weight % | weight (g) | weight % |
| glacial methacrylic acid | 368 | 16.3 | 339 | 18.0 | 394 | 19.3 |
| toluhydroquinone | 0.47 | 0.02 | 0.47 | 0.00 | 0.47 | 0.00 |
| Epoxy Resin A | 997 | 44.1 | 900 | 47.8 | 997 | 48.7 |
| maleic anhydride | 60 | 2.7 | 45 | 2.4 | 0 | 0.0 |
| trimellitic anhydride | 0 | 0.0 | 0 | 0.0 | 60 | 2.9 |
| TEBAC | 3.2 | 0.2 | 3.2 | 0.2 | 3.2 | 0.2 |
| DCPD maleate | 133 | 5.9 | 112 | 5.9 | 50 | 2.4 |
| Subtotal resin | 1590.47 | 70.4 | 1287.25 | 68.31 | 1454.25 | 71.10 |
| Styrene | 668 | 29.6 | 597 | 31.7 | 591 | 28.9 |
| phenothiazine | 0.2 | 0.01 | 0.2 | 0.01 | 0.2 | 0.01 |
| Total | 2258.67 | 100.00 | 1884.45 | 100.00 | 2045.45 | 100.00 |
| mole epoxy resin A | 5.36 | | 4.84 | | 5.36 | |
| mole methacylic acid | 4.27 | | 3.94 | | 4.58 | |
| mole maleic anhydride | 0.612 | | 0.459 | | 0.00 | |
| mole DCPD maleate | 0.50 | | 0.451 | | 0.20 | |
| DCPD maleate mole ratio* | 0.10 | | 0.09 | | 0.04 | |

*moles DCPD monomaleate/(moles DCPD monomaleate + moles other monobasic acid)

TABLE 1-B
Comparative Samples

| | CS 1 | | CS 2 | | CS 3 | |
|---|---|---|---|---|---|---|
| Ingredient | weight (g) | weight % | weight (g) | weight % | weight (g) | weight % |
| glacial methacrylic acid | 457 | 22.0 | 418 | 19.9 | 181 | 8.7 |
| toluhydroquinone | 0.47 | 0.02 | 0.47 | 0.02 | 0.47 | 0.02 |
| Epoxy Resin A | 997 | 48.0 | 997 | 47.5 | 748 | 36.1 |
| maleic anhydride | 0 | 0.0 | 53 | 2.5 | — | 0.0 |
| trimellitic anhydride | 0 | 0.0 | — | 0.0 | — | 0.0 |
| TEBAC | 3.2 | 0.2 | 3.2 | 0.2 | 3.2 | 0.2 |
| DCPD maleate | 0 | 0.0 | — | 0.0 | 521 | 25.1 |
| subtotal resin | 1457.2 | 70.11 | 1471.67 | 70.05 | 1453.67 | 70 |
| styrene | 621 | 29.9 | 629 | 29.9 | 621 | 29.9 |
| phenothiazine | 0.2 | 0.01 | 0.2 | 0.01 | 0.2 | 0.01 |
| Total | 2078.4 | 100.00 | 2100.87 | 100.00 | 2074.87 | 100.00 |
| mole epoxy resin A | 5.36 | | 5.36 | | 4.02 | |
| mole methacylic acid | 5.31 | | 4.86 | | 2.10 | |
| mole maleic ahydride | 0.00 | | 0.54 | | 0.00 | |
| mole DCPD maleate | 0.00 | | 0.00 | | 2.10 | |
| DCPD mole ratio* | 0.00 | | 0.00 | | 0.50 | |

### Example 1

Into a two-liter flask equipped with stirrer, thermometer, air sparge tube and condenser were placed 124 grams of glacial methacrylic acid, 0.47 grams of toluhydroquinone, 70 grams of DCPD, 50 grams of maleic anhydride and 13 grams of water. The temperature was raised to 115° C. and kept at that temperature for 2 hours. Then 997 grams of Epoxy Resin A, 3.2 grams of benzyltriethylammonium chloride (TEBAC) were added and the temperature raised to 120° C. and kept at that temperature for 2 hours. After cooling to 90° C., 60 grams of maleic anhydride was added and the temperature held for 1 hour at 100° C. Then 244 grams of glacial methacrylic acid and 0.4 grams (200 ppm) of toluhydroquinone were added. The mixture was heated to 115° C. and held at that temperature until the acid number was below 20. Then 668 grams of styrene monomer and 0.2 grams of phenothiazine (100 ppm) were added. The resulting vinyl ester resin had a viscosity of 920 cp (70% wt in styrene).

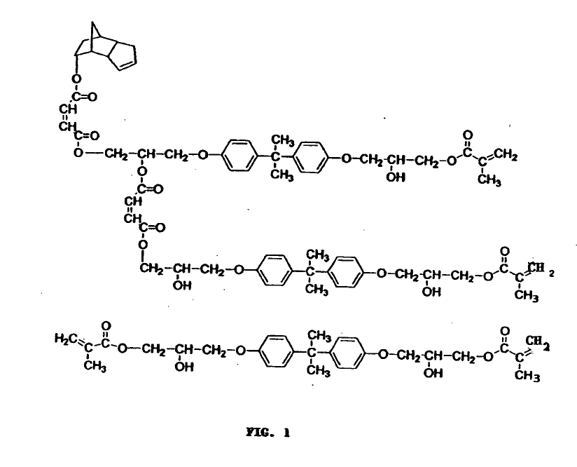

This vinyl ester resin is represented by the structure shown in FIG. 1.

### Example 2

Into a two liter flask equipped with stirrer, thermometer, air sparge tube and condenser were placed 900 grams of Epoxy Resin A, 3.2 grams of benzyltriethylammonium chloride (TEBAC), 45 grams of maleic anhydride and 112 grams of dicyclopentadienyl monomaleate (prepared from DCPD, maleic anhydride and water) and the temperature was raised to 100° C. in 2 hours. Then 339 grams of glacial methacrylic acid and 0.47 grams (200 ppm) of toluhydroquinone were added. The mixture was heated to 115° C. and held at that temperature until the acid number was below 20. Then 597 grams of styrene monomer and 0.2 gram of phenothiazine (100 ppm) were added. The resulting vinyl ester resin had a viscosity of 600 cp (70% wt. in styrene).

The structure of this resin is similar to one in Example 1 shown in FIG. 1.

### Example 3

Into a two liter flask equipped with stirrer, thermometer, air sparge tube and condenser were placed 997 grams of Epoxy Resin A. 3.2 grams of benzyltriethylammonium chloride (TEBAC), 0.47 grams (200 ppm) of toluhydroquinone, 394 grams of glacial methacrylic acid, 60 grams of trimellitic anhydride and 50 grams of dicyclopentadienyl monomaleate (prepared from DCPD, maleic anhydride and water). The temperature was raised to 120° C. in 2 hours and held at that temperature until the acid number was below 20. Then 591 grams of styrene monomer and 0.2 gram of phenothiazine (100 ppm) were added. The resulting vinyl ester resin had a viscosity of 820 cp (70% wt. in styrene).

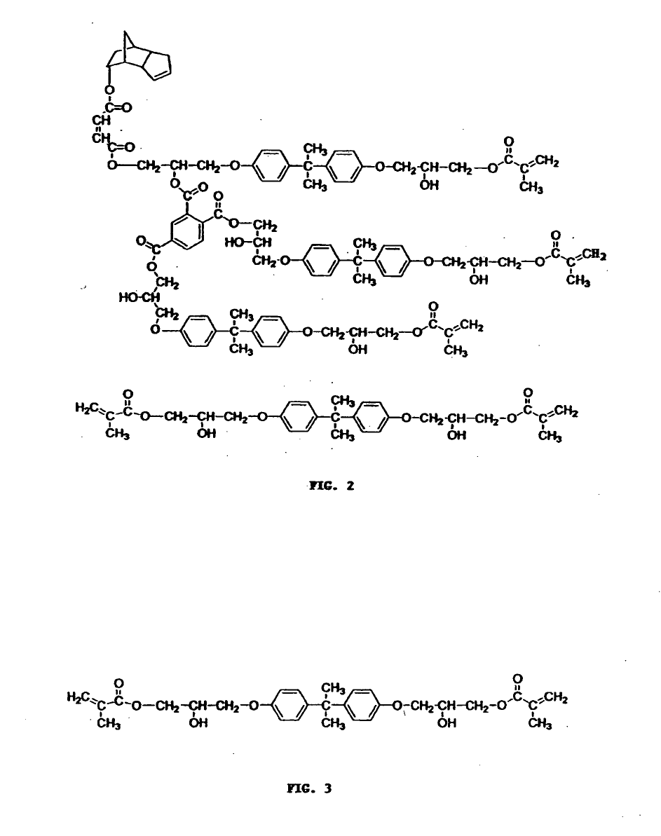

This vinyl ester resin is represented by the structure shown in FIG. 2.

### Comparative Sample 1

Into a two liter flask equipped with stirrer, thermometer, air sparge tube and condenser were placed 997 grams of Epoxy Resin A, 3.2 grams of benzyltriethylammonium chloride (TEBAC) and 457 grams of glacial methacrylic acid and 0.47 grams (200 ppm) of toluhydroquinone were added. The mixture was heated to 115° C. and held at that temperature until the acid number was below 10. Then 621 grams of styrene monomer and 0.2 gram of phenothiazine (100 ppm) were added. The resulting vinyl ester resin had a viscosity of 200 cp (70% wt. in styrene).

This vinyl ester resin is represented by the structure shown in FIG. 3.

### Comparative Sample 2

Into a two liter flask equipped with stirrer, thermometer, air sparge tube and condenser were placed 997 grams of Epoxy Resin A, 3.2 grams of benzyltriethylammonium chloride (TEBAC), 53 grams of maleic anhydride, 418 grams of glacial methacrylic acid and 0.47 grams (200 ppm) of toluhydroquinone. The mixture was heated to 115° C. and held at that temperature until the acid number was below 10. Then 629 grams of styrene monomer and 0.2 gram of phenothiazine (100 ppm) were added. The resulting vinyl ester resin had a viscosity of 480 cp (70% wt in styrene).

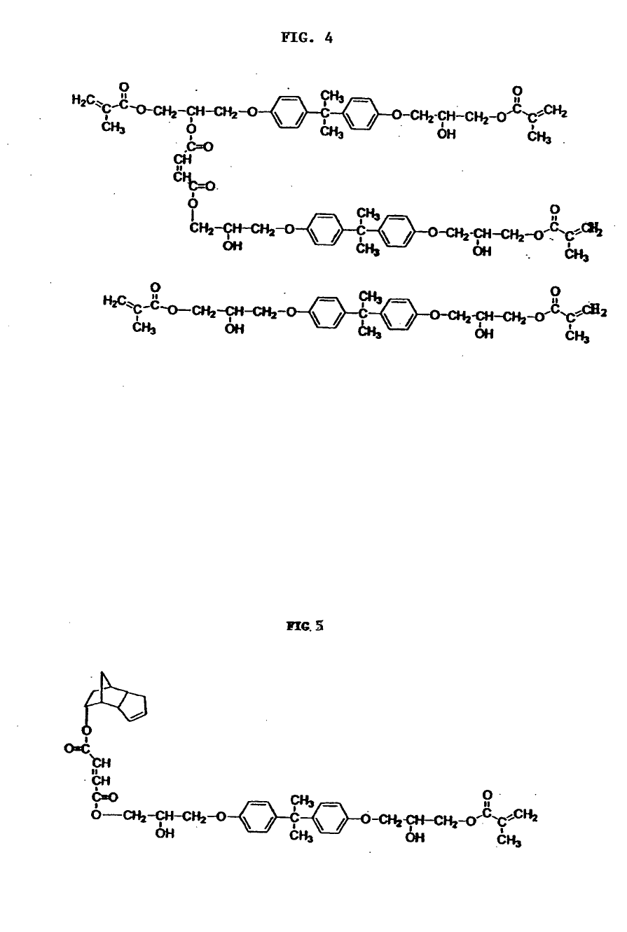

This vinyl ester resin is represented by the structure shown in FIG. 4.

### Comparative Sample 3

Into a two liter flask equipped with stirrer, thermometer, air sparge tube and condenser were placed 748 grams of Epoxy Resin A, 3.2 grams of benzyltriethylammonium chloride (TEBAC), 0.47 grams (200 ppm) of toluhydroquinone, 181 grams of glacial methacrylic acid and 521 grams of dicyclopentadienyl monomaleate (prepared from DCPD, maleic anhydride and water). The temperature was raised to 120° C. and held at that temperature for 2 hours. Then 3.0 grams of morpholine was added and the temperature was held at 120° C. until the acid number was below 20. Then 621 grams of styrene monomer and 0.2 gram of phenothiazine (100 ppm) were added. The resulting vinyl ester resin had a viscosity of 1100 cp (70% wt in styrene).

This vinyl ester resin is represented by the structure shown in FIG. 5.

The physical and performance characteristics of the resins of Examples 1-3 and Comparative Samples 1-3 were evaluated as follows.

The vinyl ester resins in this invention are evaluated for its tack-free property and for mechanical properties. The resins also are formulated as barrier coats which were applied to unsaturated polyester laminates for a hydrolytic stability testing.

A. Preparation of the Laminate Panels:

The laminate panels were prepared by first spraying an ISO/NPG type of gel coat on the glass mold and drawing down to 23 and 48 mils “wet” in thickness. Barrier coats were prepared from a solution of each resin being evaluated in a styrene solution at a concentration of 70% NVM. A layer of each barrier coat about 20 mils “wet” was then applied to the “wet” gel-coat on separate panels for each test barrier coat. The gel coat and barrier coat were cured for one hour at ambient temperature to develop physical strength before applying the main laminate. The main laminate was about 0.25 inch in thickness and about 35 wt. % glass content. The fiberglass used in the main laminate is a chopped continuous roving with 1 inch in length, and the laminate resin used in this study was a typical marine grade laminate resin. The finished test panels then cured at ambient for at least 16 hours before any test was made.

B. Hydrolytic Stability Test:

The gel coated laminates described above are then exposed to boiling water for 100 hours for the hydrolytic stability test. An ATLABO Pyrex test cell was used to test the hydrolytic stability. The test cell is fabricated of glass tubing 6″ in diameter and 2½ deep. The cell has built-in joints for a condenser, heating unit, and bubbler. The test panels are bolted to the glass tank with rubber gaskets and metal side plates to form a double dead-end flange. The test cell was filled with de-ionized water, and an electric heater is used to boil the water. The water-boiling test was stopped at a 100 hours, and the surface appearances of test panels were examined following ANSI Z124.1 test method. The results were reported in Table 2 as ANSI blister rating and ANSI overall rating. The ANSI overall rating is the summation of blister, color change, change of fiber prominent, crack, and loss of gloss on gel coat. The lower ANSI rating indicates better surface appearance of the gel-coated laminate. An ANSI rating greater than 2 is considered failure.

C. Mechanical Properties

The mechanical properties of various barrier coats were measured following the ASTM test procedures for tensile and flexural properties. The resins or barrier coats were catalyzed with 1.8% MEKP and cast between two glass plates at the thickness about ⅛ inch. The cast resins were allowed to cure at ambient temperature for at least 12 hours and post cured at 100° C. for 5 hours. The results are reported in Table 2.

D. Evaluation of Tack-Free Property

The resin composition was applied onto a glass plate in a thickness of 20 to 30 μm, and dried at 25° C. thereby obtaining a coating layer. The coating layer was touched with fingers to evaluate the tack-free property based on the following standards:
#1: None tacky
#2: Slightly tacky
#3: Some tacky
#4: Tacky

After 3 hours a rating greater than 2 is considered failure. The results are reported in Table 2.

TABLE 2
Physical Properties of Vinyl Ester Resins

| Resin Example | C. S. 1 | C. S. 2 | C. S. 3 | Ex. 1 | Ex. 2 | Ex. 3 |
|---|---|---|---|---|---|---|
| Viscosity (cps) | 200 | 480 | 1100 | 920 | 600 | 820 |
| Tensile Strength | 12380 | 13350 | 8760 | 11360 | 12070 | 11970 |
| (psi) | | | | | | |
| Elongation | 2.95% | 4.32% | 1.71% | 2.70% | 2.74% | 2.80% |
| Flexural Strength (psi) | 22170 | 23100 | 15310 | 20950 | 21600 | 24960 |
| DHT (° C.) | 125 | 110 | 85 | 102 | 107 | 117 |
| Water Resistance | | | | No blister | No blister | No blister |
| | | | | after 100 | after 100 | after 100 |
| | | | | hours | hours | hours |
| | | | | water boil | water boil | water boil |
| Tack-Free | 4 | 3 | 2 | 1 | 1 | 1 |
| Properties | Tacky | Tacky | Tacky | Tack-free | Tack-free | Tack-free |

The ratio of dicyclopentadienyl monomaleate has important effect for the physical properties as shown in Table 1. The vinyl ester resins with about 10% ratio of dicyclopentadienyl monomaleate show better properties than the vinyl ester resins with a larger ratio of dicyclopentadienyl monomaleate. The new vinyl ester resins also cost less compared to the conventional vinyl ester resin.

The new vinyl ester resin has a VOC around 30%, which meets the new MACT standard of styrene emissions for marine industry.

1. A vinyl ester resin comprising the reaction product of:
an epoxy resin having at least two epoxy groups per molecule;
a polybasic anhydride;
unsaturated monobasic acids comprising up to about 10 molar percent
dicyclopentadienyl monomaleate based on the total unsaturated monobasic acids.

2. The vinyl ester of claim 1 wherein the resin has a viscosity of less than about 1200 cp measured at a shear of 500 s⁻¹ in styrene at 70% non-volatile matter.

3. The vinyl ester of claim 1 wherein the epoxy resin is a bisphenol based epoxy resin, and novolac based epoxy resin or mixture thereof.

4. The vinyl ester of claim 1 wherein the monobasic acids further comprise ethylenically unsaturated monocarboxylic acids.

5. The vinyl ester of claim 1 wherein the ethylenically unsaturated monocarboxylic acid is one or more of the group consisting of acrylic acid, methacrylic acid, crotonic acid, alpha-phenylacrylic acid, alphacyclohexlacrylic acid, cyanoacrylic acid, and methoxyacrylic acid, and the hydroxyalkyl acrylate or methacrylate half esters of dicarboxylic acids.

6. The vinyl ester of claim 7 wherein the monocarboxylic acid is acrylic acid or methacrylic acid.

7. The vinyl ester of claim 1 wherein the dicyclopentadienyl monomaleate is an adduct of (i) dicyclopentadiene, maleic acid or maleic anhydride and water or (ii) DCPD alcohol and maleic anhydride.

8. The vinyl ester of claim 1 wherein the dicyclopentadienyl monomaleate is made in situ.

9. The vinyl ester of claim 1 wherein the polybasic anhydride is one or more of the group consisting of maleic anhydride, alpha-chloromaleic anhydride, tetrahydrophthalic anhydride, itaconic anhydride, trimellitic anhydride and phthalic anhydride, hexahydrophthalic anhydride, pyromelletic dianhydride, and succinic anhydride.

10. The vinyl ester of claim 9 wherein the polybasic anhydride is maleic anhydride or trimellitic anhydride.

11. The vinyl ester of claim 1 further comprising at least one reactive monomer.

12. The vinyl ester of claim 11 wherein the reactive monomer is selected from the group consisting of styrene, alpha-methylstyrene, unsaturated esters, and unsaturated acids.

13. The vinyl ester of claim 12 wherein the unsaturated acid is at least one of methylmethacrylate, methylacrylate, or 2-hydroxyethyl methacrylate.

14. The vinyl ester of claim 12 wherein the unsaturated ester is acrylic and methacrylic esters or vinyl laurate.

15. The vinyl ester of claim 12 wherein the unsaturated acid is acrylic and alpha-alkylacrylic acids, butenoic acid, allylbenzoic acid or vinylbenzoic acid.

16. The vinyl ester of claim 12 wherein the unsaturated ester is at least one multifunctional (meth)acrylate monomers.

17. The vinyl ester of claim 16 wherein the multifunctional (meth)acrylate monomer is tripropylene glycol diacrylate.

18. The vinyl ester of claim 12 wherein the diolefin is butadiene, isoprene or methylpentadiene.

19. The vinyl ester of claim 12 wherein the esters of polycarboxylic acids is diallyl phthalate, divinly succinate, diallyl maleate, divinyl adipate or dichloroallyl tetrahydrophthalate.

20. The vinyl ester of claim 1 further comprising at least one esterification catalyst.

21. The vinyl ester of claim 1 further comprising at least one stabilizer.

22. The vinyl ester of claim 1 further comprising a curing agent.

23. A barrier coat or gel coat comprising:
a vinyl ester resin comprising the reaction product of:
an epoxy resin having at least two epoxy groups per molecule;
a polybasic anhydride; and
unsaturated monobasic acids comprising up to about 10 molar percent
dicyclopentadienyl monomaleate based on the total unsaturated monobasic acids, and
a reactive monomer,
wherein the vinyl ester resin has a viscosity of less than about 1200 cp measured at a shear of 500 s⁻¹ in styrene at 70% non-volatile matter.

24. The barrier coat or gel coat of claim 23 further characterized as having at least 65% non-volatile matter.

25. The barrier coat or gel coat of claim 23 further characterized as having at least 70% non-volatile matter.

26. The barrier coat or gel coat of claim 23 wherein the resin has a viscosity of less than about 1000 cp measured at a shear of 500 s⁻¹ in styrene at 70% non-volatile matter.

27. The barrier coat or gel coat of claim 23 wherein the epoxy resin is a glycidyl polyether of polyhydric phenols and polyhydric alcohols.

28. The barrier coat or gel coat of claim 23 wherein the glycidyl polyether is a condensation product of bis-phenol A or novolac.

29. The barrier coat or gel coat of claim 23 wherein the monobasic acids further comprise ethylenically unsaturated monocarboxylic acids.

30. The barrier coat or gel coat of claim 23 wherein the ethylenically unsaturated monocarboxylic acid is one or more of the group consisting of acrylic acid, methacrylic acid, crotonic acid, alpha-phenylacrylic acid, alphacyclohexlacrylic acid, cyanoacrylic acid and methoxyacrylic acid.

31. The barrier coat or gel coat of claim 30 wherein the monocarboxylic acid is acrylic acid or methacrylic acid.

32. The barrier coat or gel coat of claim 23 wherein the polybasic anhydride is one or more of the group consisting of maleic anhydride, alpha-chloromaleic anhydride, tetrahydrophthalic anhydride, itaconic anhydride, trimellitic anhydride and fumaric anhydride.

33. The barrier coat or gel coat of claim 23 wherein the polybasic anhydride is maleic anhydride or trimellitic anhydride.

34. The barrier coat or gel coat of claim 23 wherein the reactive monomer is selected from the group consisting of styrene, alpha-methylstyrene, dichlorostyrene, vinyl naphthalene, vinyl phenol, unsaturated esters, unsaturated acids, halides, nitriles, such as acrylonitrile, methacrylonitrile, diolefins and esters of polycarboxylic acids.

35. The barrier coat or gel coat of claim 34 wherein the unsaturated ester is acrylic and methacrylic esters or vinyl laurate.

36. The barrier coat or gel coat of claim 34 wherein the unsaturated acid is acrylic and alpha-alkylacrylic acids, butenoic acid, allylbenzoic acid or vinylbenzoic acid.

37. The barrier coat or gel coat of claim 34 wherein the halide is vinyl chloride or vinylidene chloride.

38. The barrier coat or gel coat of claim 34 wherein the diolefin is butadiene, isoprene or methylpentadiene.

39. The barrier coat or gel coat of claim 34 wherein the esters of polycarboxylic acids is diallyl phthalate, divinly succinate, diallyl maleate, divinyl adipate or dichloroallyl tetrahydrophthalate.

40. The barrier coat or gel coat of claim 23 further comprising at least one stabilizer.

41. The barrier coat or gel coat of claim 23 further comprising a curing agent.

42. A process for preparing a vinyl ester, the process comprising the steps of:
combining a an epoxy resin having at least two epoxy groups per molecule, a polybasic anhydride; and unsaturated monobasic acids comprising up to about 10 molar percent dicyclopentadienyl monomaleate based on the total unsaturated monobasic acids to form a reaction mixture; and,
heating the reaction mixture such that the reaction mixture reacts to form a vinyl resin,
wherein the vinyl ester resin has a viscosity of less than about 1200 cp measured at a shear of 500 s⁻¹ in styrene at 70% non-volatile matter.

43. The process of claim 42 wherein the dicyclopentadienyl monomaleate is formed in situ or it is prepared separately.

44. The process of claim 42 wherein the reaction mixture is heated to a temperature between about 50° C. to about 150° C.

45. The process of claim 42 wherein the reaction mixture is heated to a temperature between about 60° C. to about 120° C.

46. The process of claim 42 wherein the reaction mixture is reacted until the reaction mixture has an acidity of about 0.015 eq/100 grams or less.

47. The process of claim 42 wherein the reaction mixture is reacted in the presence of at least one solvent or diluent.

48. The process of claim 42 wherein the reaction mixture is reacted at a pressure greater than atmospheric pressure.

49. The process of claim 42 wherein the reaction mixture is reacted at a pressure less than atmospheric pressure.

50. The process of claim 42 wherein the epoxy resin is a glycidyl polyether of polyhydric phenols and polyhydric alcohols.

51. The process of claim 42 wherein the glycidyl polyether is a condensation product of bisphenol A.

52. The process of claim 42 wherein the monobasic acids further comprise ethylenically unsaturated monocarboxylic acids.

53. The process of claim 42 wherein the ethylenically unsaturated monocarboxylic acid is one or more of the group consisting of acrylic acid, methacrylic acid, crotonic acid, alphaphenylacrylic acid, alphacyclohexlacrylic acid, cyanoacrylic acid and methoxyacrylic acid.

54. The process of claim 53 wherein the monocarboxylic acid is acrylic acid or methacrylic acid.

55. The process of claim 42 wherein the polybasic anhydride is one or more of the group consisting of maleic anhydride, alpha-chloromaleic anhydride, tetrahydrophthalic anhydride, itaconic anhydride, trimellitic anhydride and fumaric anhydride.

56. The process of claim 42 wherein the polybasic anhydride is maleic anhydride or trimellitic anhydride.

57. The process of claim 42 wherein the reaction mixture further comprises at least one esterification reaction catalyst.

58. The process of claim 57 wherein the esterification reaction catalyst is selected from the group consisting of benzyltrimethylammonium sulfate, tetramethylammonium chloride, benzyltrimethylammonium sulfate, tetramethylammonium chloride, benzyltrimethylammonium nitrate, diphenyldimethylammonium chloride, benzyltrimethylammonium chloride, diphenyldimethylammonium nitrate, diphenylmethylsulfonium chloride, tricyclohexylsulfonium bromide, triphenylmethylphosphonium iodide, diethyldibutylphosphonium nitrate, trimethylsulfonium chloride, dicyclohexyldialkylphosphonium iodide, benzyltrimethylammonium thiocyanate and mixtures thereof.

59. The process of claim 57 wherein the esterification reaction catalyst is present in an amount of about 0.01% to about 3% by weight, based on the weight of the reactants.

60. The process of claim 57 wherein the esterification reaction catalyst is present in an amount of about 0.3% to about 2% by weight, based on the weight of the reactants.

61. A thermosettable composition comprising from 25 to 90 weight percent of the vinylester resin of claim 1 with one or more unsaturated polyester resins.
